(19) United States
(12) Patent Application Publication
(10) Pub. No.: US 2004/0150722 A1
(43) Pub. Date: Aug. 5, 2004

(54) Image sensing apparatus and control method for image sensing apparatus

(76) Inventor: Shigeru Hiroki, Kanagawa (JP)

Correspondence Address: MORGAN & FINNEGAN, L.L.P., 345 PARK AVENUE, NEW YORK, NY, 10154, US

(21) Appl. No.: 10/649,966

(22) Filed: Aug. 26, 2003

(30) Foreign Application Priority Data
Aug. 27, 2002 (JP) 2002-247476

(51) Int. Cl. H04N 5/225

(52) U.S. Cl. 348/207.1

(57) ABSTRACT

An image sensing apparatus comprises: a setting unit for setting a sensing condition for image sensing; a sensing unit for sensing an image in accordance with the sensing condition set by the setting unit; and a transmitting unit for transmitting, by electronic mail, the sensing condition when the image was sensed by the sensing unit.

### FIELD OF THE INVENTION

The present invention relates to an image sensing apparatus having a communication function and a control method for the image sensing apparatus.

### BACKGROUND OF THE INVENTION

In the recent years, image sensing apparatuses such as digital cameras connected to the Internet have become popular, and it is a widespread practice that the images sensed by such image sensing apparatuses are transmitted by electronic mail.

Recently, the electronic mail transmission function of an image sensing apparatus has been used to automatically transmit sensed images by electronic mail by setting an electronic mail address for a transmission destination in advance. The use of this function allows the image sensing apparatus to be used as a surveillance camera or security camera which enables the user to see the images sensed by the image sensing apparatus placed in a remote place by receiving electronic mail.

Cases (1) to (3) described below are examples of how an image sensing apparatus is used as a surveillance camera or security camera.

(1) Sensed images are transmitted by electronic mail at a predetermined time or at predetermined intervals.

(2) Image sensing is performed when a senor is connected to the image sensing apparatus and the sensor reacts, and the sensed image is transmitted by electronic mail.

(3) Image sensing is performed when a microphone is mounted in the image sensing apparatus and the sound level input from the microphone is equal to or higher than a predetermined level, and the sensed image is transmitted by electronic mail.

For example, case (1) is effective in checking the safety of children, pets, and the like from a remote place. Cases (2) and (3) are effective in monitoring a person who breaks into a home in the absence of its residents or watching attempts to damage a car or the like.

According to the prior art, however, the user who has received electronic mail cannot know the specific conditions under which the received image data was obtained by image sensing, and hence the user who has received the electronic mail may not see the image at a proper time. In addition, the user cannot know the contents of the image data distributed through the received electronic mail unless he/she actually sees the image.

### SUMMARY OF THE INVENTION

It is an object of the present invention to solve the problem in the prior art and facilitate determination of a reason for image sensing (e.g., whether image sensing is periodically performed or a sensor has reacted) even if an image sensing apparatus is placed in a place remote from a user.

Other objects of the present invention will be apparent from the following description of the specification and drawings.

In order to achieve the above object, an image sensing apparatus, a control method for the image sensing apparatus, and the like according to the present invention are characterized by having the following arrangements.

The above-described object of the present invention is achieved by an image sensing apparatus comprising:

setting means for setting a sensing condition for image sensing;

sense means for sensing an image in accordance with the sensing condition set by the setting means; and

transmitting means for transmitting, by electronic mail, the sensing condition when the image was sensed by the sense means.

The above-described object of the present invention is achieved by a control method for an image sensing apparatus comprising:

a storing step of storing a sensing condition for image sensing;

a sensing step of sensing an image in accordance with the sensing condition stored in the storing step; and

a transmitting step of transmitting, by electronic mail, the sensing condition when the image was sensed in the sensing step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an image sensing apparatus according to the first, third, fourth, and sixth embodiments;

FIG. 2 is a view for explaining the contents of a text sentence storage area 107 in the first, third, seventh, and ninth embodiments;

FIG. 3 is a view showing the contents of mail to be transmitted by an image sensing apparatus 101 in the first embodiment;

FIG. 4 is a view exemplifying the contents of sensing conditions set in a sensing condition setting area 115;

FIG. 5 is a flow chart showing the operation of the image sensing apparatus;

FIG. 6 is a flow chart for explaining the flow of processing of image image sensing and electronic mail transmission;

FIG. 7 is a block diagram showing the arrangement of an image sensing apparatus according to the second and fifth embodiments;

FIG. 8 is a view for explaining the contents of a text sentence storage area 107 in the second and eighth embodiments;

FIG. 9 is a view for explaining the contents of mail to be transmitted by an image sensing apparatus 110a in the second embodiment;

FIG. 10 is a flow chart for explaining the flow of processing of image data loading and electronic mail transmission in the second embodiment;

FIG. 11 is a view for explaining the contents (sensing condition and time) of mail to be transmitted by an image sensing apparatus 101 in the third embodiment;

FIG. 12 is a view for explaining the contents (sensing condition, date, and time) of mail to be transmitted by the image sensing apparatus 101 in the third embodiment;

FIG. 13 is a flow chart for explaining the flow of processing of image image sensing and electronic mail transmission in the third embodiment;

FIG. 14 is a view for explaining the contents (only time) of mail to be transmitted by the image sensing apparatus 101 in the third embodiment;

FIG. 15 is a view for explaining the contents (only date and time) of mail to be transmitted by the image sensing apparatus 101 in the third embodiment;

FIG. 16 is a view for explaining the contents of a text sentence storage area 107 in the fourth, sixth, 10th, and 12th embodiments;

FIG. 17 is a view for explaining the contents of mail to be transmitted by an image sensing apparatus 101 in the fourth embodiment;

FIG. 18 is a flow chart for explaining the flow of processing of image image sensing and electronic mail transmission in the fourth embodiment;

FIG. 19 is a view for explaining the contents of a text sentence storage area 107 in the fifth embodiment;

FIG. 20 is a view for explaining the contents of mail to be transmitted by an image sensing apparatus 111a in the fifth embodiment;

FIG. 21 is a flow chart for explaining the flow of processing of image data loading and electronic mail transmission in the fifth embodiment;

FIG. 22 is a view for explaining the contents (sensing condition and time) of mail to be transmitted by an image sensing apparatus 101 in the sixth embodiment;

FIG. 23 is a flow chart for explaining the flow of processing of image image sensing and electronic mail transmission in the sixth embodiment;

FIG. 24 is a view for explaining the contents (only time) of mail to be transmitted by the image sensing apparatus 101 in the sixth embodiment;

FIG. 25 is a view for explaining the contents (only date and time) of mail to be transmitted by the image sensing apparatus 101 in the sixth embodiment;

FIG. 26 is a block diagram showing the arrangement of an image sensing apparatus according to the seventh, ninth, 10th, and 12th embodiments;

FIG. 27 is a view for explaining the contents of mail to be transmitted by an image sensing apparatus 101b in the seventh embodiment;

FIG. 28 is a flow chart for explaining the flow of processing of image image sensing and electronic mail transmission in the seventh embodiment;

FIG. 29 is a block diagram showing the arrangement of an image sensing apparatus according to the eighth and 11th embodiments;

FIG. 30 is a view for explaining the contents of mail to be transmitted by an image sensing apparatus 101c in the eighth embodiment;

FIG. 31 is a flow chart for explaining the flow of processing of image data loading and electronic mail transmission in the eighth embodiment;

FIG. 32 is a view for explaining the contents (sensing condition and time) of mail to be transmitted by an image sensing apparatus 101b in the ninth embodiment;

FIG. 33 is a view for explaining the contents (sensing condition, date, and time) of mail to be transmitted by the image sensing apparatus 101b in the ninth embodiment;

FIG. 34 is a flow chart for explaining the flow of processing of image image sensing and electronic mail transmission in the ninth embodiment;

FIG. 35 is a view for explaining the contents (only time) of mail to be transmitted by the image sensing apparatus 101b in the ninth embodiment;

FIG. 36 is a view for explaining the contents (only date and time) of mail to be transmitted by the image sensing apparatus 101b in the ninth embodiment;

FIG. 37 is a view for explaining the contents of mail to be transmitted by an image sensing apparatus 101b in the 10th embodiment;

FIG. 38 is a flow chart for explaining the flow of processing of image image sensing and electronic mail transmission in the 10th embodiment;

FIG. 39 is a view for explaining the contents of mail to be transmitted by an image sensing apparatus 101c in the 11th embodiment;

FIG. 40 is a flow chart for explaining the flow of processing of image data loading and electronic mail transmission in the 11th embodiment;

FIG. 41 is a view for explaining the contents (sensing condition and time) of mail to be transmitted by an image sensing apparatus 101b in the 12th embodiment;

FIG. 42 is a flow chart for explaining the flow of processing of image image sensing and electronic mail transmission in the 12th embodiment;

FIG. 43 is a view for explaining the contents (only time) of mail to be transmitted by the image sensing apparatus 101b in the 12th embodiment; and

FIG. 44 is a view for explaining the contents (only date and time) of mail to be transmitted by the image sensing apparatus 101b in the 12th embodiment.

### DETAILED DESCRIPTION OF THE PREFERRED EMBODIMENTS

Preferred embodiments of the present invention will now be described in detail in accordance with the accompanying drawings.

[First Embodiment]

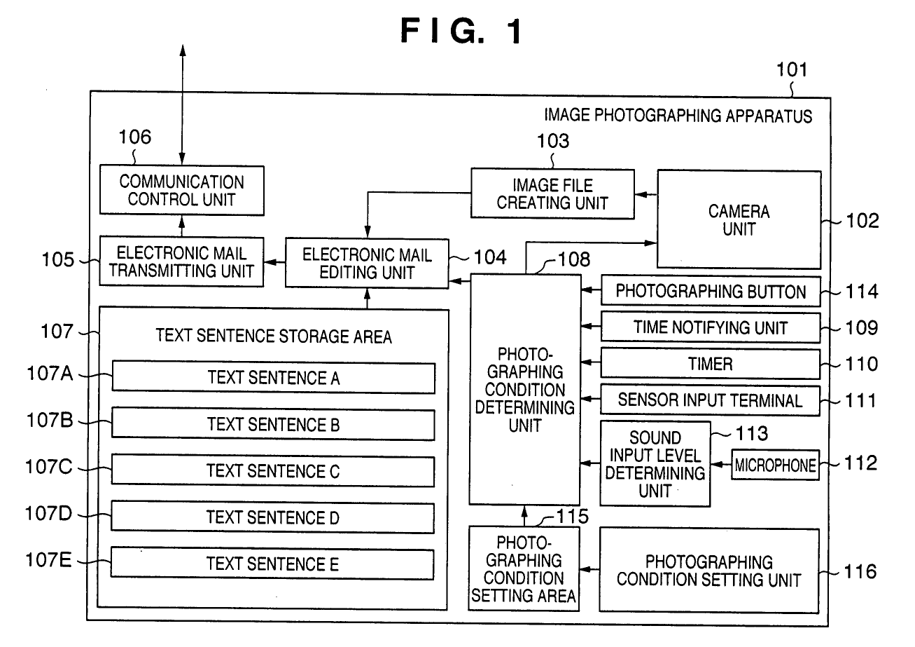

FIG. 1 is a block diagram showing the arrangement of an image sensing apparatus 101 according to the first embodiment. Reference numeral 101 denotes an image sensing apparatus having a digital camera function; 102, a digital camera unit for sensing an image; 103, an image file creating unit for filing the image sensed by the camera unit; 104, an electronic mail editing unit for creating electronic mail; 105, an electronic mail transmitting unit for transmitting the electronic mail created by the electronic mail editing unit 104; and 106, a communication control unit for controlling connection to the Internet.

Reference numeral 107 denotes a text sentence storage area in which text sentences corresponding to sensing conditions are stored; and 107A to 107E, text sentences corresponding to sensing conditions A to E.

Reference numeral 108 denotes a sensing condition determining unit for controlling the camera unit 102 and notifying the electronic mail editing unit 104 of sensing conditions.

Reference numeral 109 denotes a time notifying unit; and 110, a timer for notifying the lapse of time. The time notifying unit and timer allow the use of a predetermined time and the lapse of time as part of sensing conditions.

Reference numeral 111 denotes a sensor input terminal for making a notification when a sensor is connected to the image sensing apparatus and a sensor input is received from the sensor; 112, a microphone; 113, a sound input level determining unit for making a notification when the sound level from the microphone 112 is equal to or higher than a predetermined level; 114, a sensing button which is operated by the user of the image sensing apparatus 101 to input a photograph request; 115, a sensing condition setting area in which sensing conditions are stored; and 116, a sensing condition setting unit for setting sensing conditions.

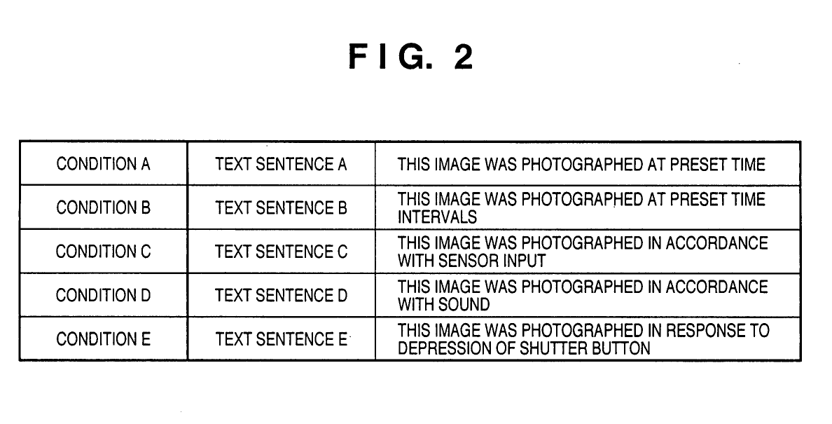

FIG. 2 is a view exemplifying the contents of the text sentence storage area 107. The text sentence storage area 107 stores the text sentences 107A to 107E explicitly stating the contents of the conditions A to E for sensed images:

condition A: take a photograph at a preset time;

condition B: take a photograph every time a preset time elapses;

condition C: take a photograph upon reception of an input from the sensor connected to the sensor input terminal 111;

condition D: take a photograph when the sound level input from the microphone 112 is equal to or higher than a predetermined level; and

condition E: take a photograph when the sensing button 114 is pressed.

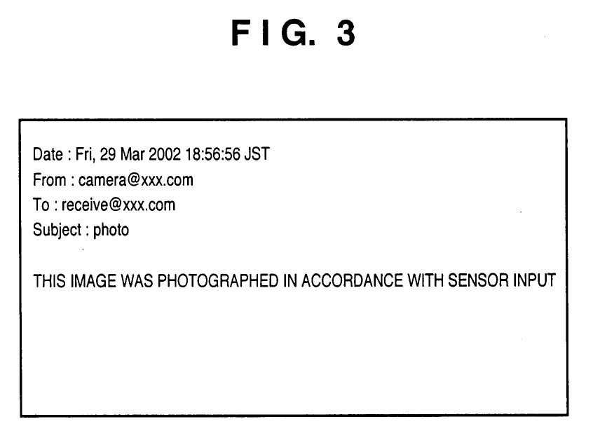

FIG. 3 is a view exemplifying the contents of mail to be transmitted by the image sensing apparatus 101. FIG. 3 shows a case of condition C (“take a photograph upon reception of an input from the sensor connected to the sensor input terminal 111). This mail is edited by the electronic mail editing unit 104 and transmitted by the electronic mail transmitting unit 105 in accordance with a predetermined transmission address.

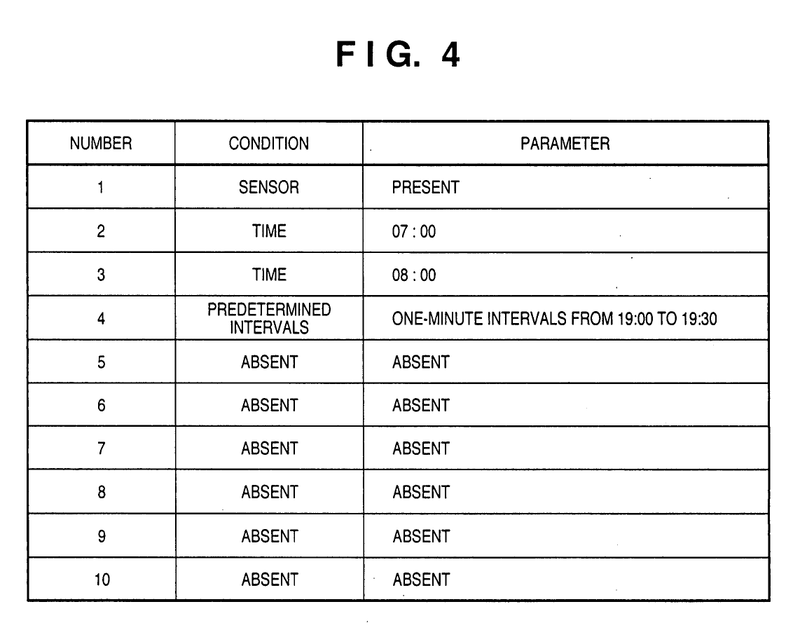

FIG. 4 is a view exemplifying the contents of the sensing condition setting area 115. Referring to FIG. 4, parameters are so set as to transmit mail upon reception of a sensor input, at the times indicated by time parameters (07:00 and 08:30), and at predetermined time intervals (one-minute intervals from 19:00 to 19:30). These sensing conditions are set by processing performed by the sensing condition setting unit 116.

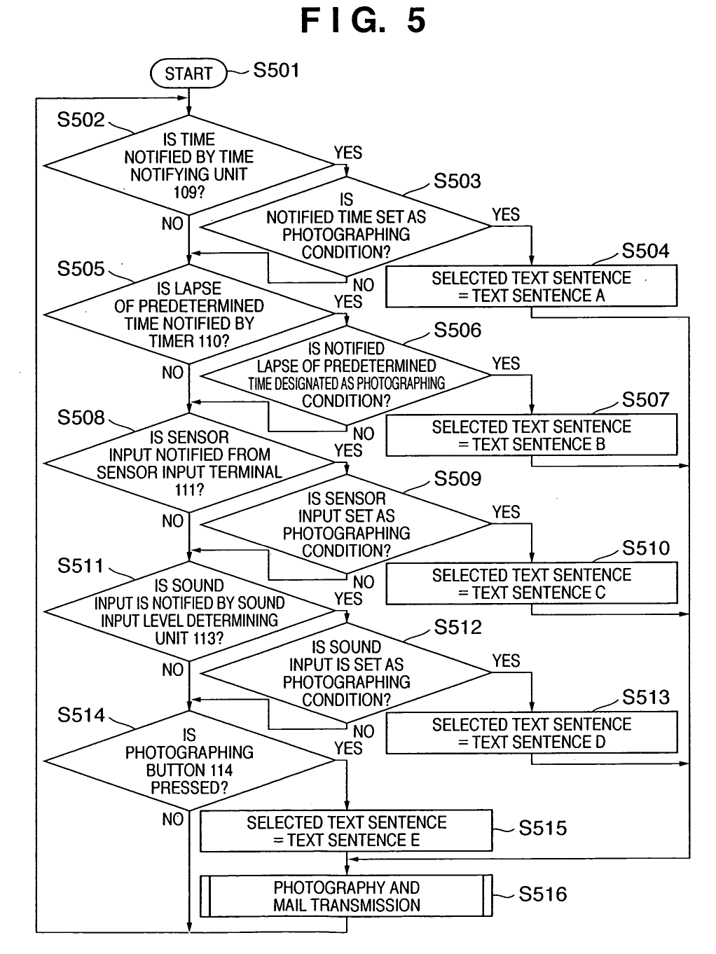

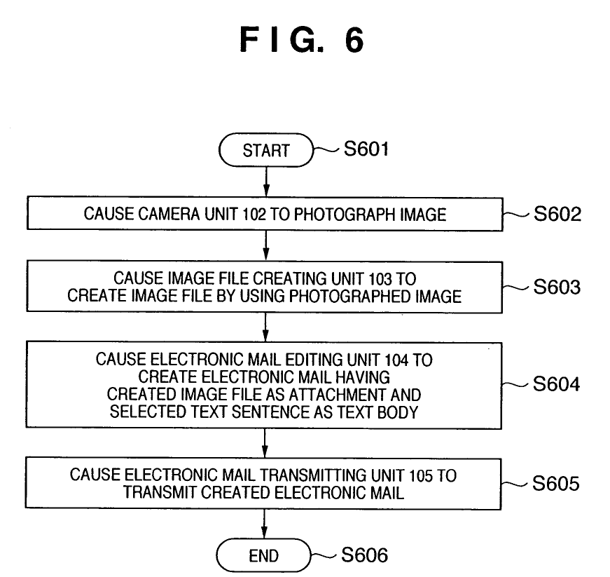

FIG. 5 is a flow chart for explaining the flow of processing in the image sensing apparatus 101 according to this embodiment. FIG. 6 is a flow chart for explaining in detail the processing of “image sensing and mail transmission” in the processing in the flow chart of FIG. 5.

The flow of processing will be described in detail below in accordance with the flow charts of FIGS. 5 and 6.

Assume that the sensing condition determining unit 108 in FIG. 1 has received a notification associated with a sensing condition such as a notification of reception of a sensor input from the sensor input terminal 111, a notification of a time, a notification of the elapse of time, a notification of detection of a sound whose sound level is equal to or higher than a predetermined level, or a notification that the sensing button 114 is pressed (YES in step S502, YES in step S505, YES in step S508, YES in step S511, or YES in step S514). In this case, the sensing condition determining unit 108 checks whether the input sensing condition is one of the conditions set in the sensing condition setting area 115 (S503, S506, S509, or S512).

If the sensing condition determining unit 108 determines that the input sensing condition is one of the conditions set in the sensing condition setting area 115 (YES in step S503, YES in step S506, YES in step S509, or YES in step S512), the electronic mail editing unit 104 selects a text sentence corresponding to the sensing condition from the text sentences stored in the text sentence storage area 107 in accordance with the sensing condition determined by the sensing condition determining unit 108 (S504, S507, S510, S513, or S515).

The camera unit 102 photographs an image (S516 and S602). The image file creating unit 103 creates an image file from the sensed image (S603). In this case, images to be sensed may include still and moving images.

The electronic mail editing unit 104 then creates electronic mail having the destination address set in advance in a memory (not shown) as a transmission destination address, the text sentence selected in accordance with the sensing condition as a message, and the created image file as an attachment (S604).

The electronic mail transmitting unit 105 transmits the created electronic mail to the destination through the Internet or the like (S605).

As described with reference to FIG. 2, sensing conditions can be set as an arbitrary combination of one or more of the conditions A to E. For example, in the case shown in FIG. 4, image sensing is performed when one of conditions (1) to (4) given below is satisfied or the sensing button 114 is pressed: (1) a sensor input is received;

(2) the time is 7:00;

(3) the time is 8:00; and

(4) at one-minute intervals from 19:00 to 19:30.

Operations for the conditions A to E will be described below.

<Operation for Condition A (“take a Photograph at a Preset Time”)>

When notified of the time from the time notifying unit 109 (YES in step S502), the sensing condition determining unit 108 makes the flow advance to step S503 to refer to the sensing condition setting area 115 to check whether the condition that image sensing is to be performed at the time notified by the time notifying unit 109 has been set (S503). If this sensing condition has been set (YES in step S503), the sensing condition determining unit 108 selects the text sentence 107A (S504) and shifts the flow to “image sensing and mail transmission” (S516).

<Operation for Condition B (“take a Photograph Every Time a Preset Time Elapses”)>

When notified of the lapse of a predetermined time from the timer 110 (S505), the sensing condition determining unit 108 refers to the sensing condition setting area 115 to check whether the condition that image sensing is to be performed at predetermined time intervals has been set (S506). If this sensing condition has been set (YES in step S506), the sensing condition determining unit 108 selects the text sentence 107B (S507) and shifts the flow to “image sensing and mail transmission” (S516).

In the case of determination of the condition B, image sensing can be performed every time a predetermined time elapses by the following method as well as the method based on the timer 110. When, for example, the time is notified by the time notifying unit 109, the sensing condition determining unit 108 refers to the sensing condition setting area 115. Assume that the condition that image sensing is to be performed at predetermined time intervals has been set. In this case, when the current time coincides with the start time of image sensing to be done at predetermined time intervals, the timer 110 is started in accordance with the setting to start image sensing under the condition set by the timer. The image sensing under the condition set by the timer is then terminated in accordance with the end time of the image sensing done at the predetermined time intervals.

<Operation for Condition C (“take a Photograph Upon Reception of an input from the sensor connected to the sensor input terminal 111”)>

When notified of the reception of a sensor input from the sensor input terminal 111 (YES in step S508), the sensing condition determining unit 108 refers to the sensing condition setting area 115 to check whether the condition that image sensing is to be performed upon reception of a sensor input has been set (S509). If this sensing condition has been set (YES in step S510), the sensing condition determining unit 108 selects the text sentence 107C (S510) and shifts the flow to “image sensing and mail transmission” (S516).

In this case, when, for example, the present invention is to be used to perform image sensing when a person breaks into a home in the absence of its residents, an infrared senor or door sensor may be used as this sensor.

<Operation for Condition D (“take a Photograph When the Sound Level Input From the Microphone 112 is Equal to or higher than a predetermined level”)>

Assume that a sound is input from the microphone 112, and the sound input level determining unit 113 determines that the sound level is equal to or higher than a predetermined level, and notifies the sensing condition determining unit 108 of the corresponding information (YES in step S511). In this case, the sensing condition determining unit 108 refers to the sensing condition setting area 115 to check whether the condition that image sensing is to be performed when such a sound is input has been set (S512). If this sensing condition has been set, the sensing condition determining unit 108 selects the text sentence 107D (S513) and shifts the flow to “image sensing and mail transmission” (S516).

<Operation for Condition E (“Take a Photograph when the Sensing Button 114 is pressed”)>

When the sensing button 114 is pressed, the sensing condition determining unit 108 selects the text sentence 107E and shifts the flow to “image sensing and mail transmission” (S516).

FIG. 3 shows an example of electronic mail to be transmitted by the image sensing apparatus 101 in the first embodiment. When a user who has received this electronic mail sees the message of the electronic mail, he/she can immediately understand that the attached image file is an image sensed on the basis of a sensor input.

That is, when a user receives mail to which an image is attached by the image sensing apparatus 101, he/she can easily know a specific sensing condition for the image data by only seeing the message of the mail.

In addition, the user can quickly take the next action on the basis of the information of the message of this mail. For example, if image sensing has been done on the basis of a sensor input, an emergent situation can be expected. The user therefore immediately sees the image even if he/she is busy. In other cases, the user may see the image later. In this manner, the user can set a priority order for the effective use of time.

In addition, devising an application for mail reception in an apparatus on the mail receiving side makes it possible to filter received images in accordance with the contents of the messages of pieces of mail. For example, received images can be stored in different folders according to the respective sensing conditions.

[Second Embodiment]

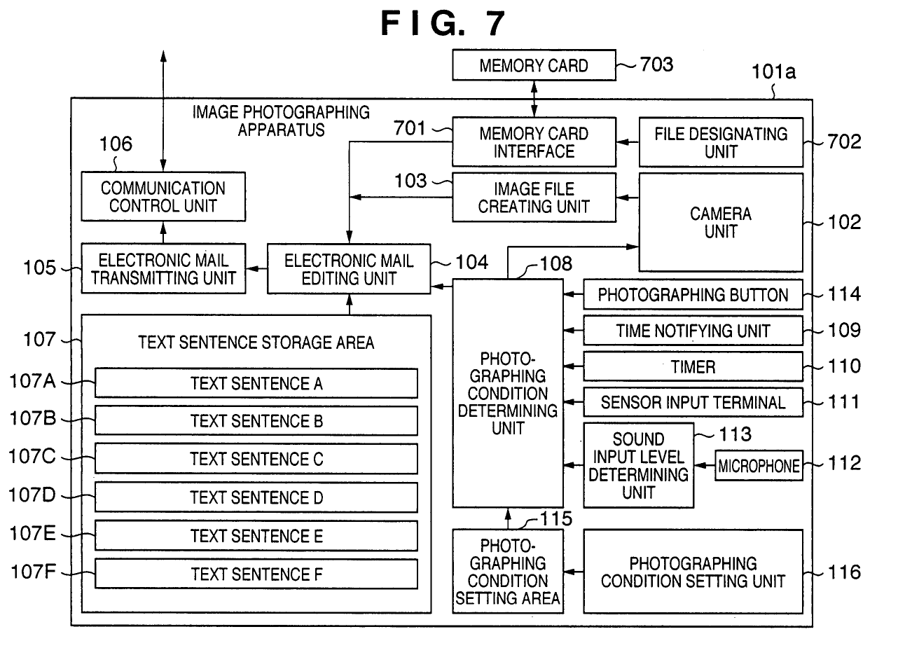

FIG. 7 is a block diagram of an image sensing apparatus 110a according to the second embodiment. Referring to FIG. 7, reference numeral 701 denotes a memory card interface for accommodating a memory card 703 in the image sensing apparatus 111a; 702, a file designating unit for designating one of the files stored in the memory card 703 which is to be transmitted; and 703, the memory card.

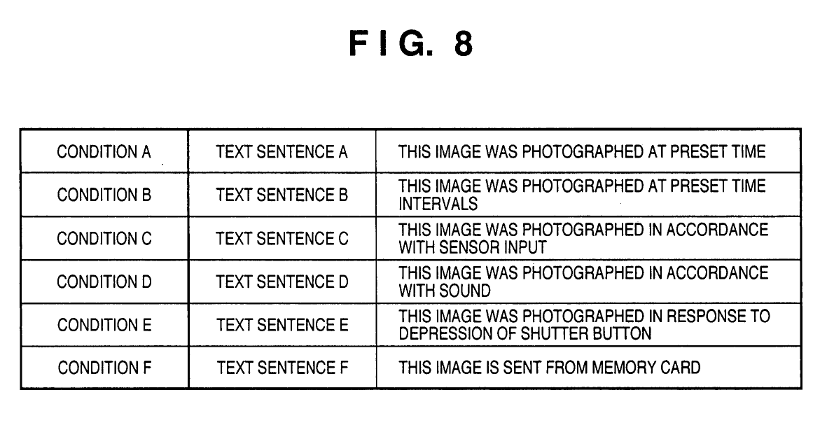

FIG. 8 is a view exemplifying the contents of a text sentence storage area 107. The contents of conditions A to E are the same as those in FIG. 2. A condition F is newly added to these conditions. The condition F specifies the corresponding data as image data stored in the memory card. A text sentence F is stored in the text sentence storage area 107.

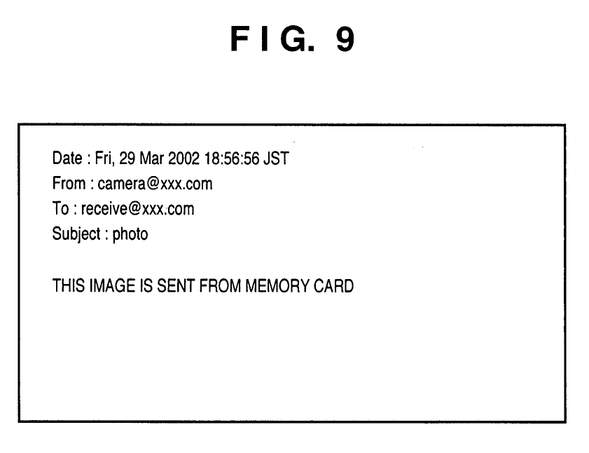

FIG. 9 shows an example of the contents of mail to be transmitted by the image sensing apparatus 101a when an image file in the memory card is transmitted as an attachment. This mail is edited by an electronic mail editing unit 104 and transmitted by an electronic mail transmitting unit 105 in accordance with a predetermined transmission address.

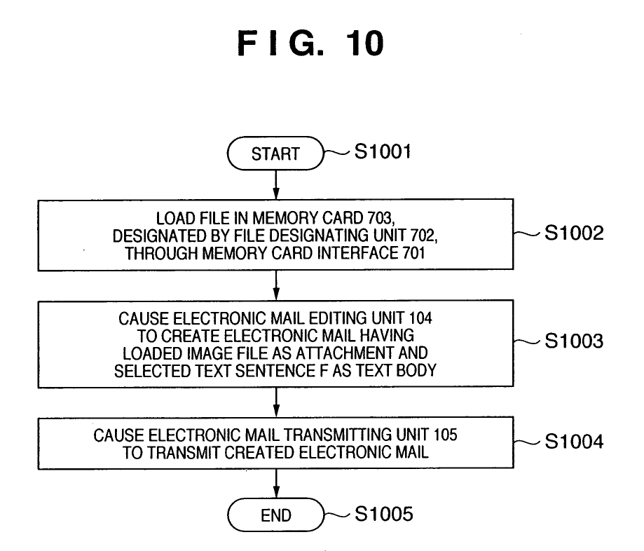

FIG. 10 is a flow chart for explaining the flow of processing in the second embodiment. If there is a sensing condition match, the image sensing apparatus 110a according to the second embodiment performs image sensing and transmits the sensed image as an attachment by electronic mail. In addition to this function which is the same function as in the first embodiment, the image sensing apparatus 110a has a function of also transmitting an image file stored in the memory card 703 as an attachment by electronic mail upon satisfaction of a predetermined condition, e.g., that image sensing is to be performed at predetermined time intervals or at a designated time. This function will be described below with reference to the flow chart of FIG. 10.

When a file in the memory card 703 is designated by the file designating unit 702, the designated file is loaded from the memory card 703 through the memory card interface 701 (S1002).

The electronic mail editing unit 104 edits electronic mail so as to have the text sentence F, as a message, which is selected from the text sentence storage area as data for specifying the corresponding data as image data stored in the memory card, while using the destination address set in advance in a memory (not shown) as a transmission destination address and the loaded image file as an attachment (S1003).

The electronic mail transmitting unit 105 transmits the edited electronic mail (S1004). The processing is then terminated.

FIG. 9 shows an example of electronic mail to be transmitted by the image sensing apparatus 101a according to the second embodiment. When a user who has received this electronic mail sees the message of the electronic mail, he/she can immediately know that the attached image file is an image file in the memory card.

In addition, the user can quickly take the next action on the basis of the information of the message of this mail. For example, a file in the memory card has a low degree of urgency, the user may see the image later. In other cases, the user may quickly see images. In this manner, the user can set a priority order for the effective use of time.

Note that the second embodiment has exemplified the memory card as a memory. However, as a memory, any medium capable of storing files, such as a RAM, hard disk, CD-ROM, or floppy disk, can be used in the same manner as described above.

[Third Embodiment]

In the third embodiment, when an image sensed in the case of a sensing condition match is to be transmitted as an attached file by electronic mail as in the first embodiment, the sensing time and date are converted into text data and inserted in the message of the electronic mail.

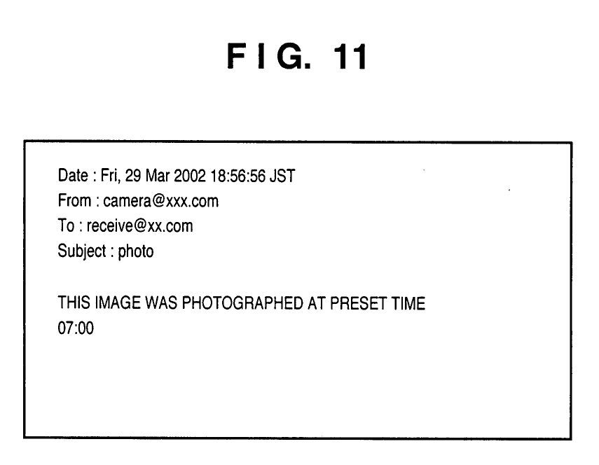

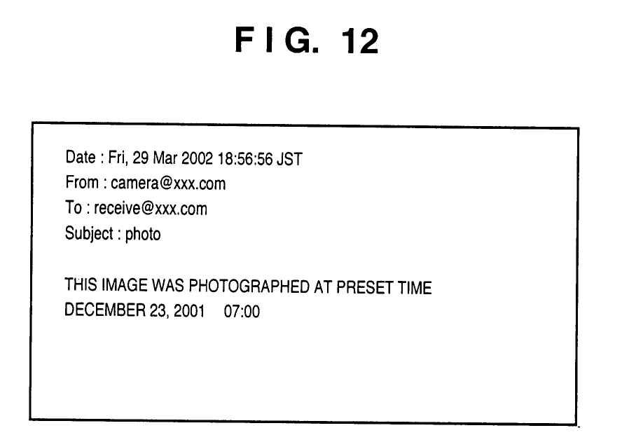

FIG. 11 is a view exemplifying the contents (sensing condition and time) of mail to be transmitted by an image sensing apparatus 101 when time information is inserted in the message of the electronic mail. FIG. 12 is a view exemplifying the contents (sensing condition, date, and time) of mail to be transmitted by the image sensing apparatus 101 when time information and date information are inserted in the message of the electronic mail. In either of the cases shown in FIGS. 11 and 12, the image file created by performing image sensing under a condition A that image sensing is to be performed at 7:00 (“take a photograph at a preset time”) (see FIGS. 2 and 4) is transmitted.

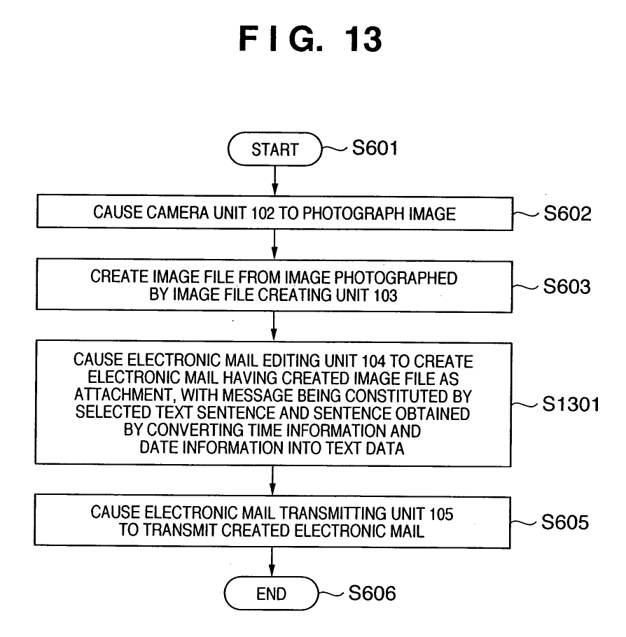

FIG. 13 is a flow chart for explaining processing in the third embodiment in the processing of “image sensing and mail transmission” (S516) in the flow chart of FIG. 5. The flow chart of FIG. 6 (first embodiment) differs from that of FIG. 13 only in step S1301.

First of all, an image is sensed by a camera unit 102 (S602). An image file creating unit 103 creates an image file on the basis of the image (S603). An electronic mail editing unit 104 then creates electronic mail having the destination address set in advance in a memory (not shown) as a transmission destination address and the created image file as an attachment, with a message being constituted by the text sentence selected in accordance with the sensing condition and the sentence obtained by converting the sensing time information and/or sensing date information into text data (S1301).

According to this embodiment, when a user who has received the electronic mail sees the message of the electronic mail, he/she can immediately know the time and/or date at which the image was sensed.

In addition, when the user receives mail to which an image is attached by the image sensing apparatus according to the third embodiment, he/she can know the sensing time and the like by only seeing the message of the mail. This allows the user to quickly take the next action. Even if the reception of mail is delayed by some cause, the user can assign a priority to image data in forward or reverse chronological order of sensing times or the like by seeing the sensing time in the message of the mail. The user who has received electronic mail can therefore effectively use time by checking image data in accordance with the priority order.

In addition, devising an application for mail reception in an apparatus on the mail receiving side makes it possible to filter received images in accordance with the sensing times/dates written in the messages of pieces of mail. For example, the images can be arranged in the order of the times written in mail messages instead of the order of the arrival times of the pieces of mail.

Furthermore, devising an application for mail reception in an apparatus on the mail receiving side by inserting date information makes it possible to filter received images in accordance with the contents of the messages of pieces of mail. For example, received images can be stored in different folders according to the respective sensing dates.

Since date information and time information are simultaneously inserted in the message of mail, the accuracy of time information improves. This makes it possible to perform accurate processing for even mail received with a delay of a day or so.

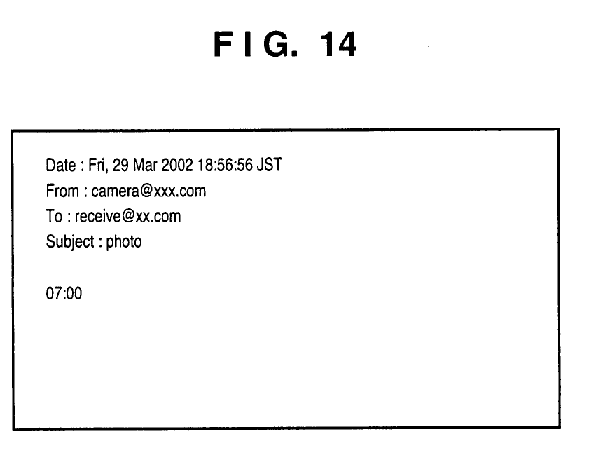

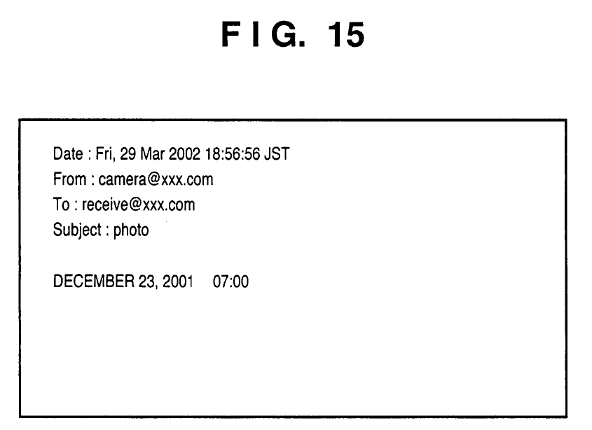

In the third embodiment, time information and date information are inserted in the message of mail, together with a sensing condition described in the first and second embodiments. However, the present invention is not limited to this edit form. Electronic mail may be edited by using only a sensing time as message data (see FIG. 14), or may be edited by using only sensing date information as test body data (FIG. 15).

[Fourth Embodiment]

In the first embodiment, a text sentence corresponding to a sensing condition is inserted in the message of electronic mail. In contrast to this, in the fourth embodiment, a text sentence corresponding to a sensing condition is inserted in the subject (subject field) of electronic mail.

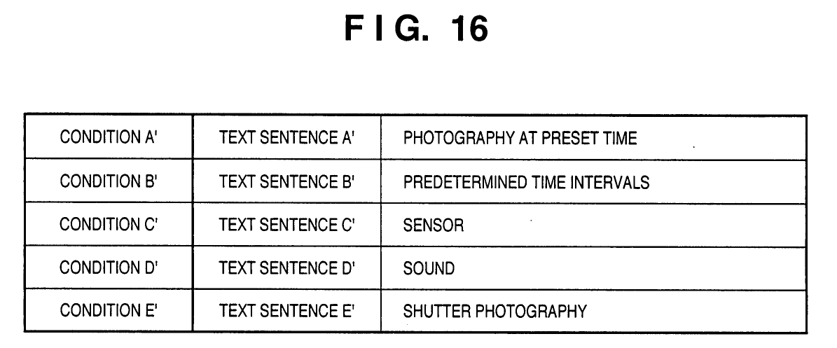

FIG. 16 is a view exemplifying the contents of text sentences which correspond to the respective conditions (A′ to E′) stored in a text sentence storage area 107 and are inserted as subjects.

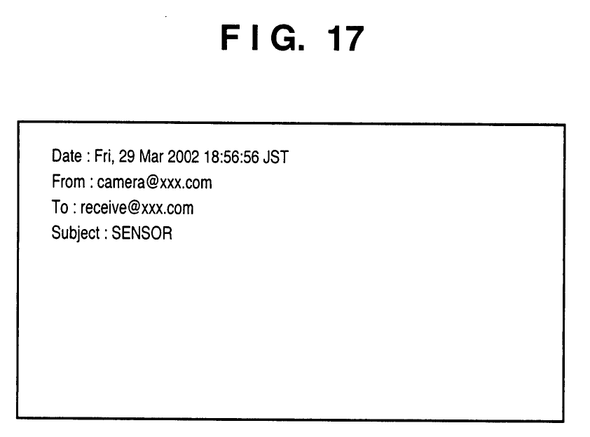

FIG. 17 shows an example of the contents of mail to be transmitted by an image sensing apparatus 101. FIG. 17 shows a case of a condition C (“take a photograph upon reception of an input from the sensor connected to a sensor input terminal 111). In this case, the text sentence “sensor” is inserted in the subject field.

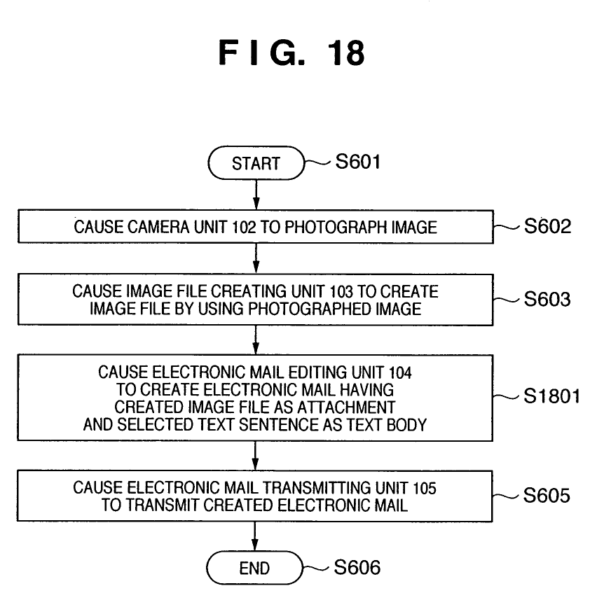

FIG. 18 is a flow chart for explaining in detail the processing of “image sensing and mail transmission” in the flow chart of FIG. 5 in the fourth embodiment. The flow chart of FIG. 6 (first embodiment) differs from that of FIG. 18 only in step S1801.

First of all, an image is sensed by a camera unit 102 (S602). An image file creating unit 103 creates an image file on the basis of the image (S603). An electronic mail editing unit 104 then creates electronic mail having a preset destination address as a transmission destination address, the created image file as an attachment, and the text sentence selected in accordance with the sensing condition as a subject (S1801).

An electronic mail transmitting unit 105 transmits the created electronic mail (S605). The processing is then terminated.

FIG. 17 shows an example of electronic mail to be transmitted by the image sensing apparatus according to the fourth embodiment. When a user who has received this electronic mail sees the subject of the electronic mail, he/she can immediately know that the attached image file is an image sensed upon reception of a sensor input.

In addition, devising an application for mail reception on an apparatus on the mail receiving side makes it possible to filter received images in accordance with the contents of the subjects of pieces of mail. For example, received images can be stored in different folders according to the respective sensing conditions.

[Fifth Embodiment]

In the second embodiment, a text sentence indicating that the corresponding file is a file in a memory card is inserted in the message of electronic mail. In the fifth embodiment, a text sentence indicating that the corresponding file is a file in a memory card is inserted in the subject of electronic mail.

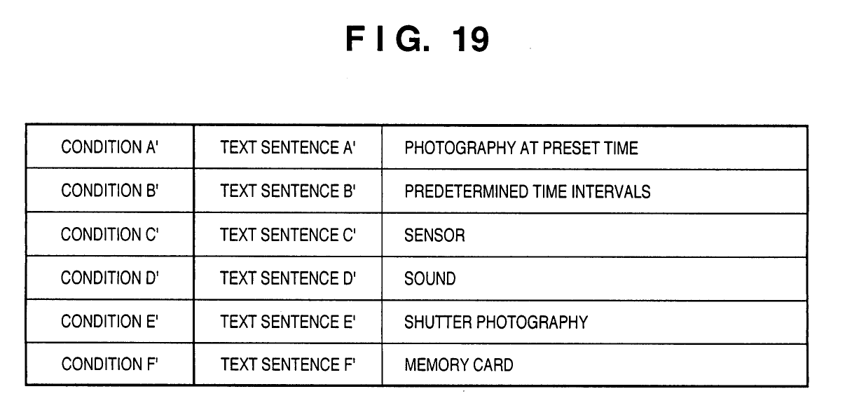

FIG. 19 is a view exemplifying the contents of a text sentence storage area 107. The text sentence storage area 107 stores text sentences A′ to F′ explicitly stating the contents of conditions A′ to F” for sensed images. The text sentence F′ corresponds to a case wherein an image file in a memory card is transmitted as an attachment by mail.

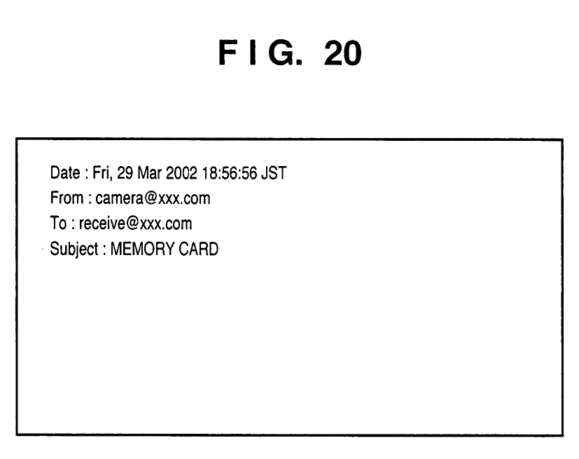

FIG. 20 shows an example of the contents of mail to be transmitted by an image sensing apparatus 101a when an image file in the memory card is transmitted as an attachment. FIG. 20 shows a case of the condition F′ (image data is input from the memory card). An electronic mail editing unit 104 edits this mail. An electronic mail transmitting unit 105 transmits the mail in accordance with a predetermined transmission address.

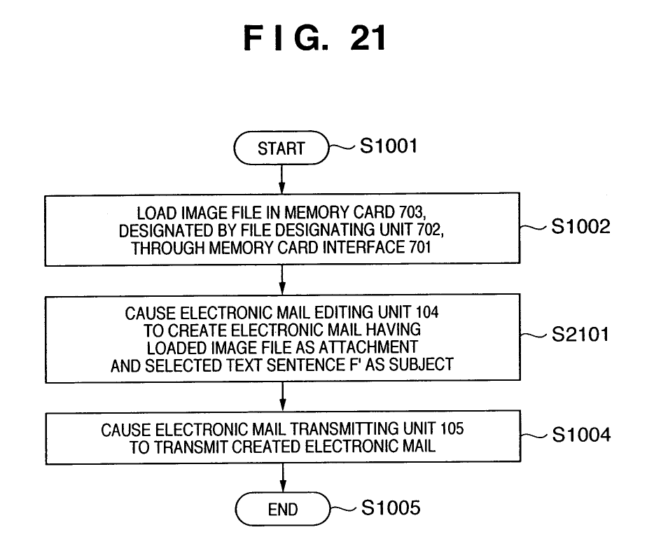

FIG. 21 is a flow chart for explaining the flow of processing in the fifth embodiment. If there is a sensing condition match, the image sensing apparatus 111a according to this embodiment performs image sensing and transmits the sensed image as an attachment by electronic mail. In addition to this function which is the same function as described in the fourth embodiment, the image sensing apparatus 110a has a function of also transmitting an image file stored in a memory card 703 as an attachment by electronic mail upon satisfaction of a predetermined condition, e.g., that image sensing is to be performed at predetermined time intervals or at a designated time.

Processing in the fifth embodiment will be described below with reference to the flow chart of FIG. 21. First of all, when a file in the memory card 703 is designated by a file designating unit 702 (see FIG. 7), the designated file is loaded from the memory card 703 through a memory card interface 701 (S1002). The electronic mail editing unit 104 then creates electronic mail having a preset destination address as a transmission destination address, the loaded image file as an attachment, and the selected text sentence F′ as a subject (S2101). The processing in this step differs from that in step S1003 in FIG. 10.

An electronic mail transmitting unit 105 transmits created electronic mail in accordance with a predetermined transmission address (S1004). The processing is then terminated.

FIG. 20 shows an example of electronic mail to be transmitted by the image sensing apparatus according to the fifth embodiment. When a user who has received this electronic mail sees the subject of the electronic mail, he/she can immediately know that the attached image file is an image file in the memory card.

In addition, only seeing the subject of the mail allows the user to know that the attached image file is an image file in the memory card. This makes it possible to quickly take the next action. For example, a file in the memory card has a low degree of urgency, the user may see the image later. In other cases, the user may quickly see images. In this manner, the user can set a priority order for the effective use of time.

In addition, devising an application for mail reception in an apparatus on the mail receiving side makes it possible to filter received images in accordance with the contents of the subjects of pieces of mail. For example, when a file in the memory card is received, the image can be stored in a folder different from other folders.

Note that the fifth embodiment has exemplified the memory card as a memory. However, as a memory, any medium capable of storing files, such as a RAM, hard disk, CD-ROM, or floppy disk, can be used in the same manner as described above.

[Sixth Embodiment]

In the third embodiment, the sensing time and date are converted into text data and inserted in the message of electronic mail. In the sixth embodiment, the sensing time and date are converted into text data and inserted in the subject of electronic mail.

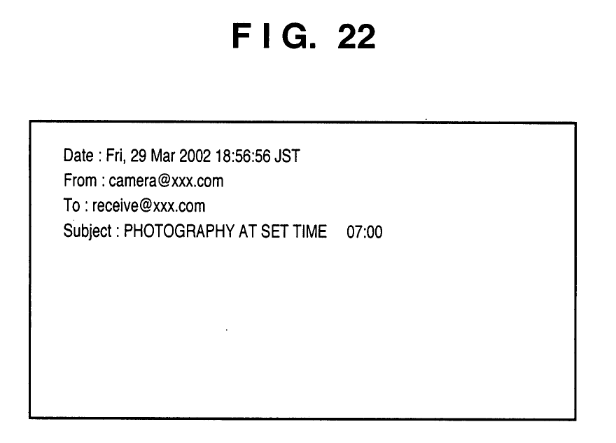

FIG. 22 is a view exemplifying the contents of electronic mail to be transmitted by an image sensing apparatus 101 when time information is inserted in the subject of the mail. FIG. 22 shows a case wherein an image file created by performing image sensing under a condition A that image sensing is to be performed at 7:00 (“take a photograph at a preset time” (see FIGS. 2 and 4)) is transmitted.

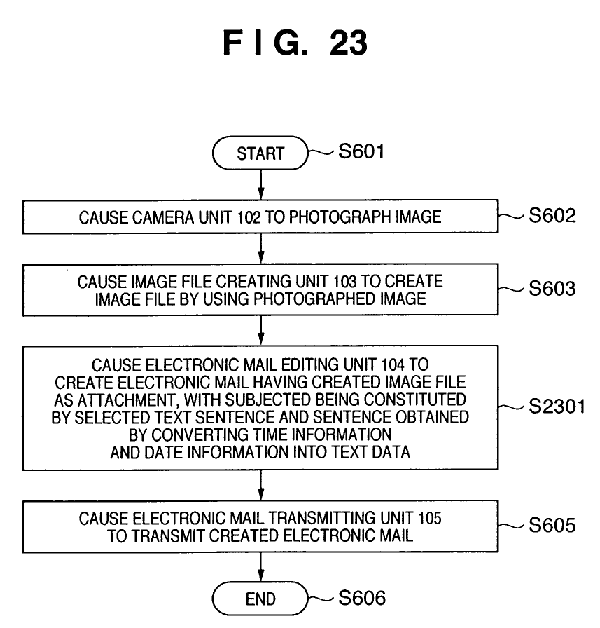

FIG. 23 is a flow chart for explaining processing in the sixth embodiment in the processing of “image sensing and mail transmission” (S516) in the flow chart of FIG. 5. The flow charts of FIGS. 6 and 13 differ in step S2301.

First of all, an image is sensed by a camera unit 102 (S602). An image file creating unit 103 creates an image file on the basis of the image (S603). An electronic mail editing unit 104 then creates electronic mail having a preset destination address as a transmission destination address and the created image file as an attachment, with a subject being constituted by the text sentence selected in accordance with the sensing condition and the sentence obtained by converting sensing time information and/or sensing date information into text data (S2301).

An electronic mail transmitting unit 105 transmits the created electronic mail (S605). The processing is then terminated.

According to this embodiment, when a user who has received the electronic mail sees the subject of the electronic mail, he/she can immediately know that the time and/or date at which the image was sensed.

In addition, upon reception of mail to which an image is attached by the image sensing apparatus according to the sixth embodiment, the user can know the sensing time by only seeing the subject of the mail. This allows the user to quickly take the next action. Even if the reception of mail is delayed by some cause, the user can assign a priority to image data in forward or reverse chronological order of sensing times or the like by seeing the sensing time or the like in the subject. The user who has received electronic mail can therefore effectively use time by checking image data in accordance with the priority order.

In addition, devising an application for mail reception in an apparatus on the mail receiving side makes it possible to filter received images in accordance with the sensing times written in the messages of pieces of mail. For example, the images can be arranged in the order of the times written in the pieces of mail subjects instead of the order of the arrival times of pieces of mail.

Furthermore, devising an application for mail reception in an apparatus on the mail receiving side by inserting date information makes it possible to filter received images in accordance with the sensing dates written in the subjects of pieces of mail. For example, received images can be stored in different folders according to the respective sensing dates.

Since date information and time information are simultaneously inserted in the subject of mail, the accuracy of time information improves. This makes it possible to perform accurate processing for even mail received with a delay of a day or so.

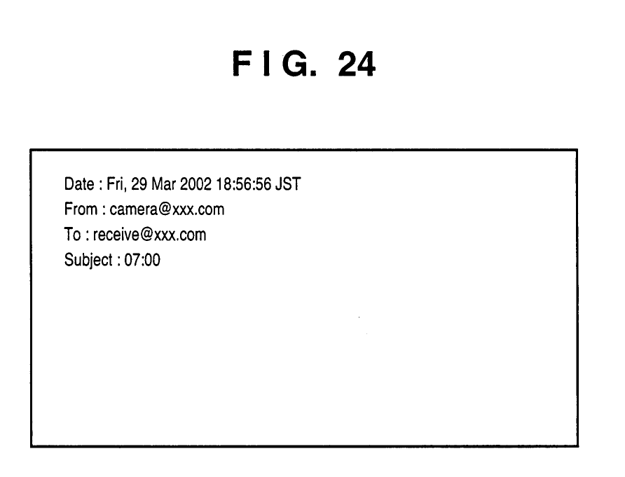

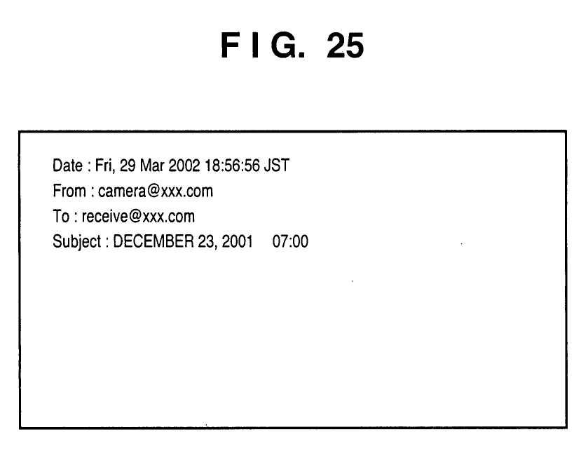

In the sixth embodiment, time information and date information are inserted in the subject of mail, together with a sensing condition described in the fourth and fifth embodiments. However, the present invention is not limited to this edit form. Electronic mail may be edited by using only a sensing time as subject data (see FIG. 24), or may be edited by using only sensing time information and sensing date information as subject data (FIG. 25).

[Seventh Embodiment]

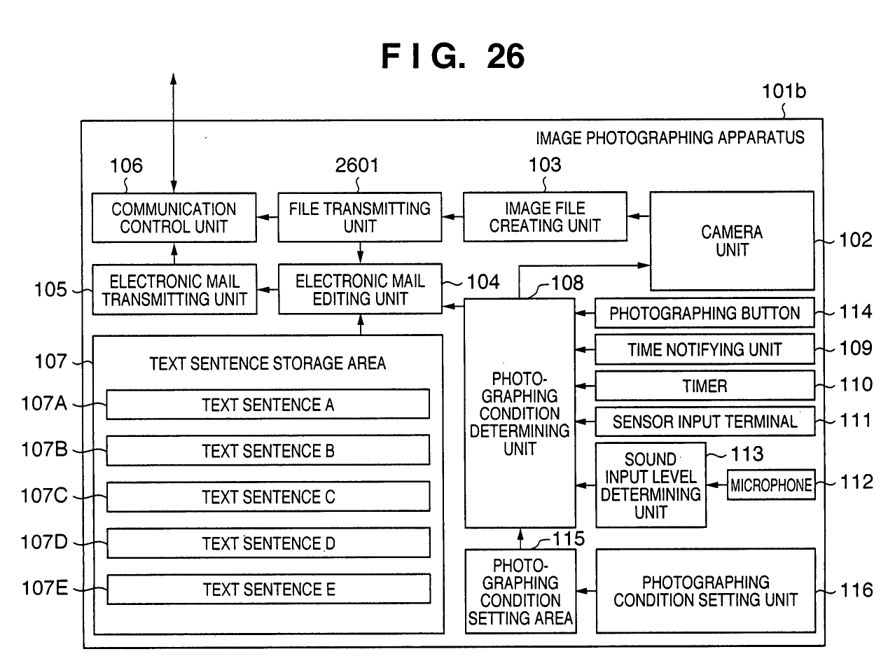

FIG. 26 is a block diagram showing the arrangement of an image sensing apparatus 101b according to the seventh embodiment. Referring to FIG. 26, reference numeral 2601 denotes a file transmitting unit for transmitting an image file to a server on the Internet.

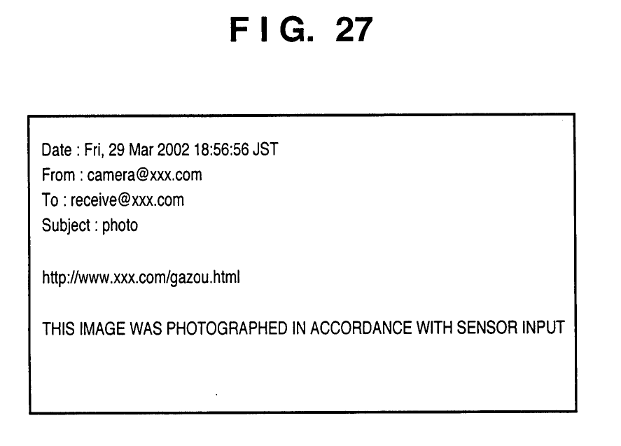

FIG. 27 shows an example of the contents of mail to be transmitted by the image sensing apparatus 101b. FIG. 27 shows a case of a condition C (“take a photograph upon reception of an input from the sensor connected to a sensor input terminal 111”).

This mail contains a text sentence indicating a sensing condition and a link (URL) to the image.

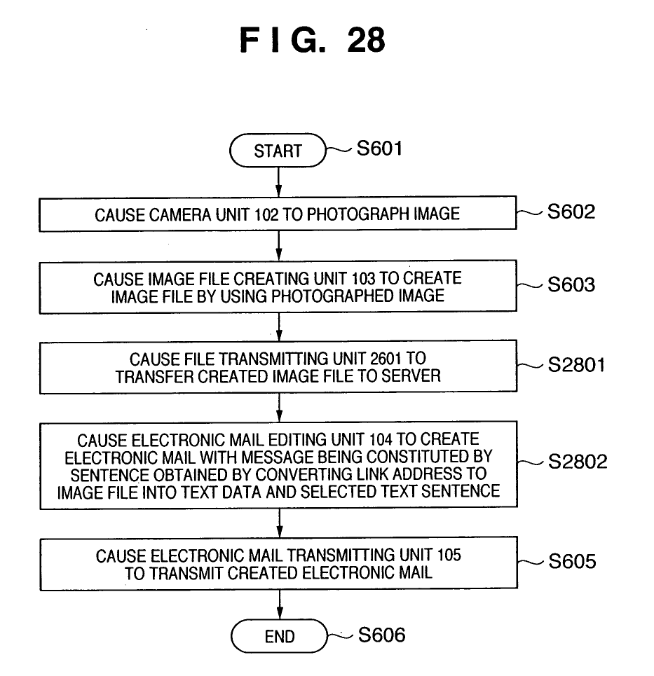

FIG. 28 is a flow chart for explaining processing in the seventh embodiment in the processing of “image sensing and mail transmission” (S516) in the flow chart of FIG. 5. The flow chart of FIG. 6 (first embodiment) differs from that of FIG. 28 in steps S2801 and S2802.

First of all, an image is sensed by a camera unit 102 (S602). An image file creating unit 103 creates an image file on the basis of the image (S603). The file transmitting unit 2601 then transfers the created image file to a server designated in advance (S2801). An electronic mail editing unit 104 edits electronic mail having the destination address set in advance in a memory (not shown) as a transmission destination address, with a link address to the image file transferred to the server being converted into text data and the text sentence selected in accordance with a sensing condition being used as a message (S2802). An electronic mail transmitting unit 105 transmits the created electronic mail (S605). The processing is then terminated.

In general, an image file is transmitted using FTP (File Transfer Protocol), and the transmitted image file is browsed with a browser using HTTP (Hyper Text Transfer Protocol). When an image file is to be transferred, the address of a server is the address (e.g., ftp://ftp.xxx.com/) of an FTP server, and a link address to the image file is the URL (e.g., http://www.xxx.com/gazou.html) of a homepage where the image file can be browsed. This link address is sent from the file transmitting unit 2601 to the electronic mail editing unit 104. As has been described in the preceding embodiments, a sensing condition can be specified by a combination of one or more conditions A to E.

FIG. 27 shows an example of electronic mail to be transmitted by the image sensing apparatus 101b. When a user who has received this electronic mail sees the message of the electronic mail, he/she can immediately know that the image file at the link address is an image sensed upon reception of a sensor input.

In addition, according to this embodiment, when the user receives mail on which a link address for accessing image data is written by the image sensing apparatus 101b, he/she can immediately know the specific sensing condition for the image by only seeing the message of the mail. This makes it possible to quickly take the next action.

Furthermore, if image data is separated from electronic mail and only sensing information is transmitted through the electronic mail, the transmission load on the electronic mail can be reduced.

[Eighth Embodiment]

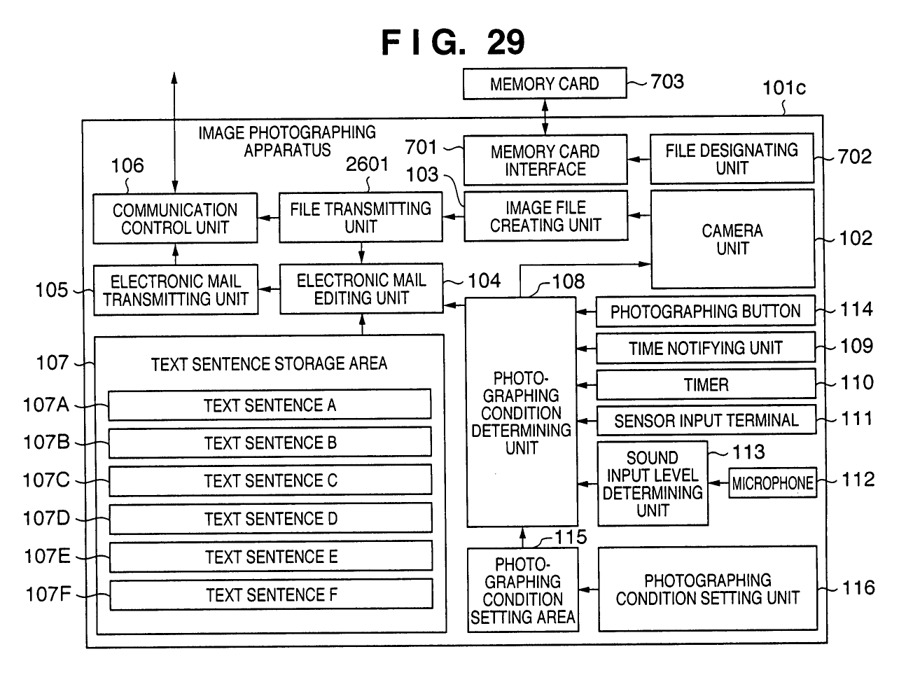

FIG. 29 is a block diagram of an image sensing apparatus 101c according to the eighth embodiment. Referring to FIG. 29, reference numeral 701 denotes a memory card interface for accommodating a memory card 703 in the image sensing apparatus 10c; 702, a file designating unit for designating one of the files stored in the memory card 703 which is to be transmitted; 703, a memory card; and 2601, a file transmitting unit for transmitting an image file to a server on the Internet.

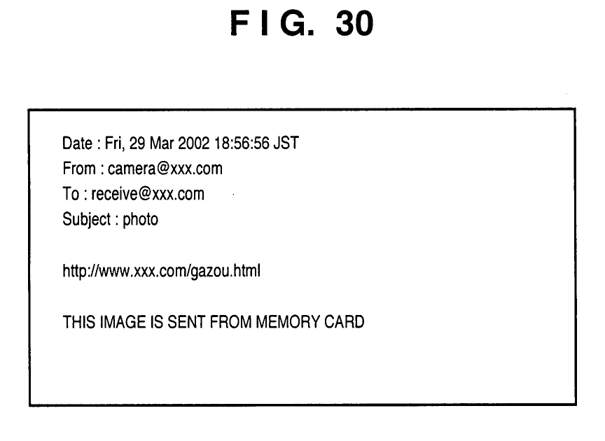

FIG. 30 is a view exemplifying the contents of mail to be transmitted by the image sensing apparatus 101c when an image file in a memory card is transmitted to a server on the Internet.

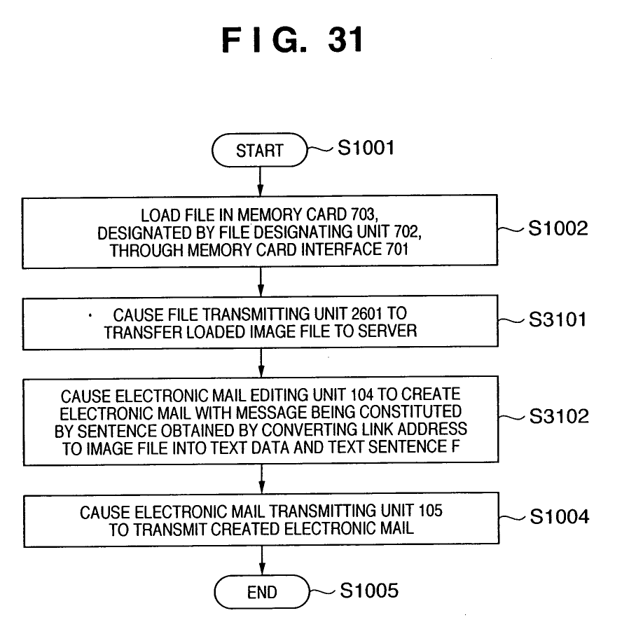

FIG. 31 is a flow chart for explaining the flow of processing in the eighth embodiment. If there is a sensing condition match, the image sensing apparatus 101b according to the eighth embodiment performs image sensing, transmits the sensed image to a server on the Internet, and transmits a link address to the image by electronic mail. In addition to this function which is the same function as in the seventh embodiment, the image sensing apparatus 101b has a function of transmitting an image file stored in the memory card 703 to the server on the Internet and transmitting a link address to the image by electronic mail. The flow of processing in the eighth embodiment will be described with reference to the flow chart of FIG. 31.

First of all, when a file in the memory card 703 is designated by the file designating unit 702, the designated file is loaded from the memory card 703 through the memory card interface 701 (S1002). The file transmitting unit 2601 transfers the loaded image file to the server (S3101). An electronic mail editing unit 104 then creates electronic mail having the destination address set in advance in a memory (not shown) as a transmission destination address, with a message being constituted by the sentence obtained by converting the link address to the image file transferred to the server into text data and a text sentence indicating that the transferred image data is an image in the memory (S3102). An electronic mail transmitting unit 105 transmits the created electronic mail (S605). The processing is then terminated.

According to this embodiment, when a user who has received the electronic mail sees the message of the electronic mail, he/she can immediately know that the image file at the link address written in the message is an image file in the memory card.

According to the eighth embodiment, when the user receives mail on which a link address to an image is written by the image sensing apparatus, he/she can identify the received image file as a file in the memory card by only seeing the test body of the mail. This makes it possible to quickly take the next action. For example, a file in the memory card has a low degree of urgency, the user may see the image later. In other cases, the user may quickly see images. In this manner, the user can set a priority order for the effective use of time.

Note that the eighth embodiment has exemplified the memory card as a memory. However, as a memory, any medium capable of storing files, such as a RAM, hard disk, CD-ROM, or floppy disk, can be used in the same manner as described above.

[Ninth Embodiment]

In the ninth embodiment, when an image sensed upon coincidence between an input sensing condition and a set sensing condition is to be transmitted to a server on the Internet and a link address to the image file is to be transmitted by electronic mail, the sensing time and/or sensing date are converted into text data to be inserted in the message of the electronic mail.

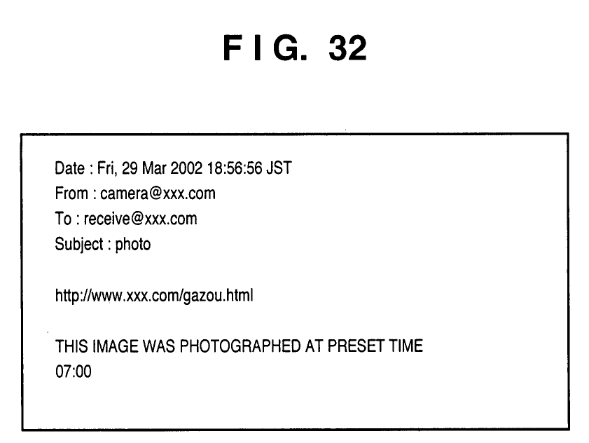

FIG. 32 is a view exemplifying the contents of electronic mail to be transmitted by an image sensing apparatus 101b when time information is inserted in the message of the mail. An electronic mail editing unit 104 selects a text sentence (107A to 107E) corresponding to a sensing condition from a text sentence storage area 107 on the basis of the determination result obtained by a sensing condition determining unit 108, and adds the information of a set time or date to the selected text sentence, thus editing the information as data of the message of the electronic mail.

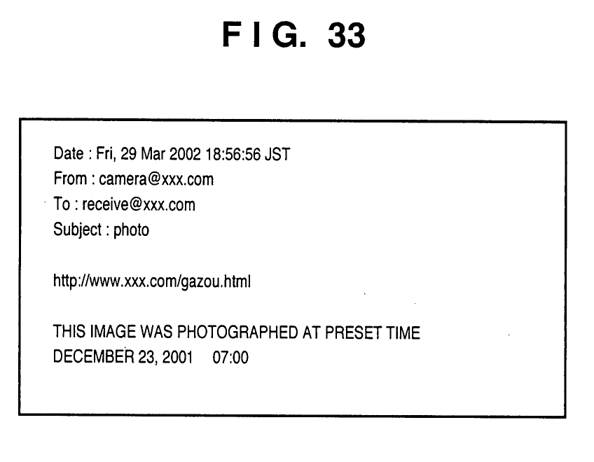

FIG. 33 is a view exemplifying the contents of electronic mail when time information and date information are edited as data of the message of the electronic mail. In either of the cases shown in FIGS. 32 and 33, an image file obtained by performing image sensing under a condition A that image sensing is to be performed at the preset time, 7:00 (“take a photograph at a preset time” (see FIG. 2)).

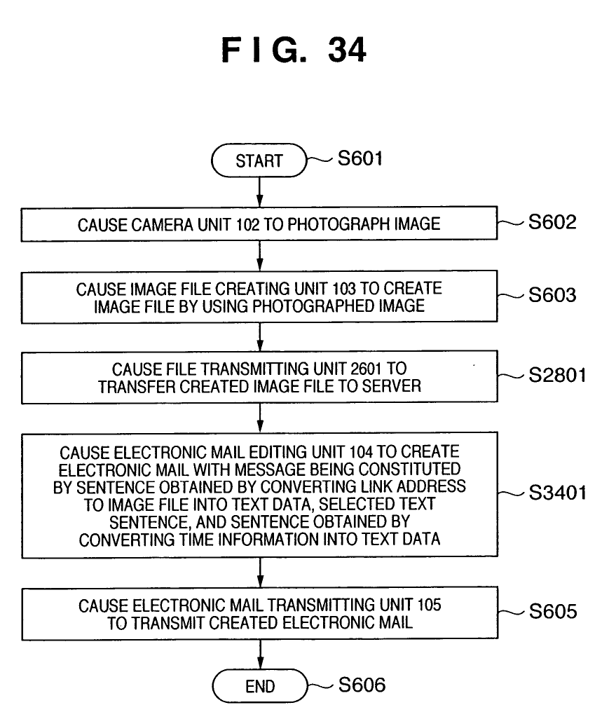

FIG. 34 is a flow chart for explaining in detail processing in the ninth embodiment in the processing of “image sensing and mail transmission” (S516) in the flow chart of FIG. 5.

First of all, an image is sensed by a camera unit 102 (S602). An image file creating unit 103 creates an image file on the basis of the image (S603). A file transmitting unit 2601 then transfers the created image file to a server (S2801). An electronic mail editing unit 104 then creates electronic mail having the destination address set in advance in a memory (not shown) as a transmission destination address, with a message being constituted by the sentence obtained by converting the link address to the image file transferred to the server into text data, the text sentence selected in accordance with a sensing condition, and the sentence obtained by converting the time information into text data (S3401). An electronic mail transmitting unit 105 transmits the created electronic mail (S605). The processing is then terminated.

FIG. 32 shows an example of electronic mail to be transmitted by the image sensing apparatus according to the ninth embodiment. When a user who has received this electronic mail sees the message of the electronic mail, he/she can immediately knows the time when the image at the link address was sensed.

According to the ninth embodiment, when the user receives mail on which a link address to an image is written by the image sensing apparatus, he/she can know the sensing time by only seeing the message of the mail. This makes it possible to quickly take the next action. Even if, for example, the reception of mail is delayed by some cause, the user can assign a priority to image data in forward or reverse chronological order of sensing times or the like by seeing the sensing time in the message. The user who has received electronic mail can therefore effectively use time by checking image data in accordance with the priority order.

In the ninth embodiment, time information is inserted in the message of mail. However, date information may be inserted in the message of mail.

Since date information and time information are simultaneously inserted in the message of mail, the accuracy of time information improves. This makes it possible to perform accurate processing for even mail received with a delay of a day or so.

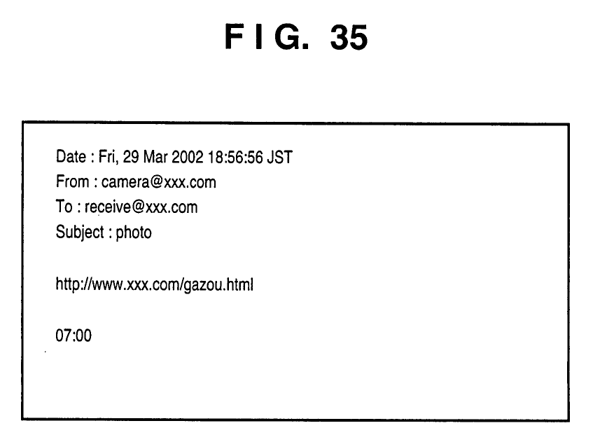

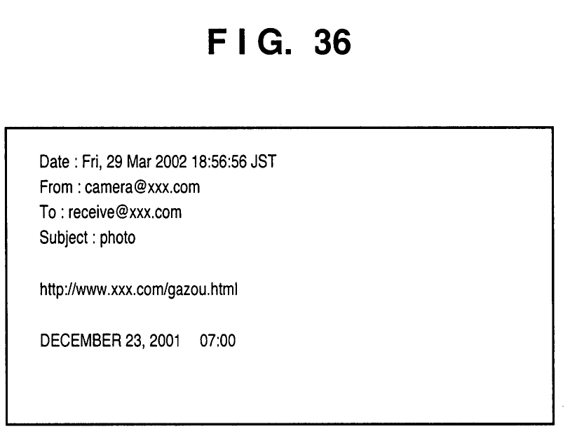

In the ninth embodiment, time information and date information are inserted in the message of mail, together with a sensing condition described in the seventh and eighth embodiments. However, the present invention is not limited to this edit form. Electronic mail may be edited by using only a sensing time as message data (see FIG. 35), or may be edited by using only sensing time information and sensing date information as test body data (FIG. 36).

[10th Embodiment]

In the seventh embodiment, a text sentence corresponding to a sensing condition is inserted in the message of electronic mail. In the 10th embodiment, a text sentence corresponding to a sensing condition is inserted in the subject of electronic mail.

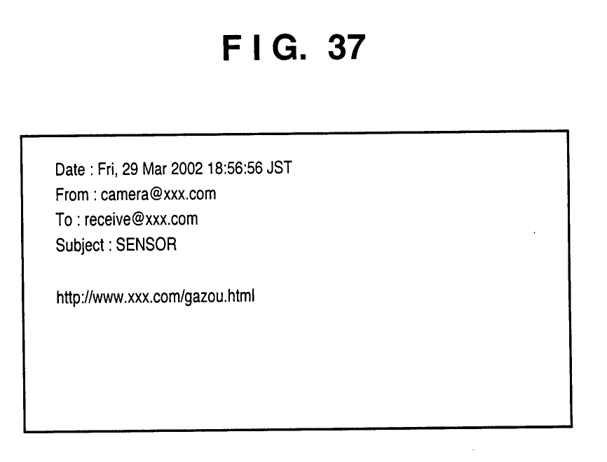

FIG. 37 shows an example of the contents of mail to be transmitted by an image sensing apparatus 101.

FIG. 37 shows case of a condition C “take a photograph upon reception of an input from the sensor connected to a sensor input terminal 111).

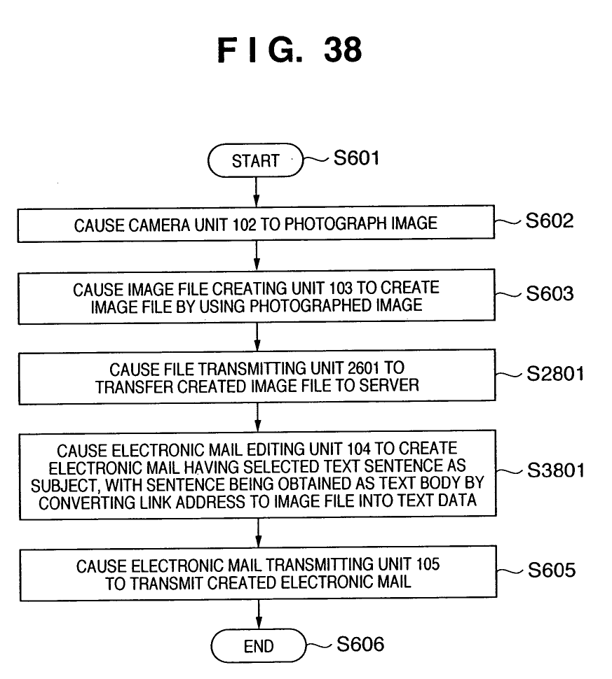

FIG. 38 is a flow chart for explaining processing in the 10th embodiment in the processing of “image sensing and mail transmission” in the flow chart of FIG. 5.

First of all, an image is sensed by a camera unit 102 (S602). An image file creating unit 103 creates an image file on the basis of the image (S603). A file transmitting unit 2601 then transfers the created image file to a server (S2801). An electronic mail editing unit 104 then creates electronic mail having the destination address set in advance in a memory (not shown) as a transmission destination address, with the text sentence selected in accordance with a sensing condition being inserted in the subject, and the sentence obtained by converting a link address to the image file transferred to the server into text data being inserted in the message (S3801). An electronic mail transmitting unit 105 transmits the created electronic mail (S605). The processing is then terminated.

Note that selection of a text sentence corresponding to a sensing condition in step S3801 conforms to the steps in the flow chart of FIG. 5.

FIG. 37 shows an example of electronic mail to be transmitted by the image sensing apparatus according to the 10th embodiment. When a user who has received this electronic mail sees the subject of the electronic mail, he/she can immediately know that the image file at the link address written in the message is an image sensed upon reception of a sensor input.

According to the 10th embodiment, when the user receives mail on which a link address to an image is written by an image sensing apparatus 101b, he/she can know a specific sensing condition for the image by only seeing the subject of the mail. This makes it possible to quickly take the next action. For example, since a sensor input as a condition is expected to indicate a high degree of urgency, the user preferentially checks image data obtained under this condition as compared with those obtained under other sensing conditions, thus allowing effective use of time.

[11th Embodiment]

In the eighth embodiment, a text sentence indicating that the corresponding file is a file in a memory card is inserted in the message of electronic mail. In the 11th embodiment, a text sentence indicating that the corresponding file is a file in a memory card is inserted in the subject of electronic mail.

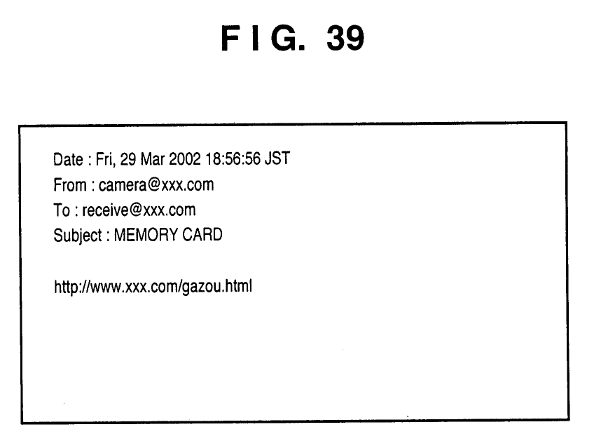

FIG. 39 shows an example of the contents of mail to be transmitted by a image sensing apparatus 101c when an image file in a memory card is transmitted as an attachment.

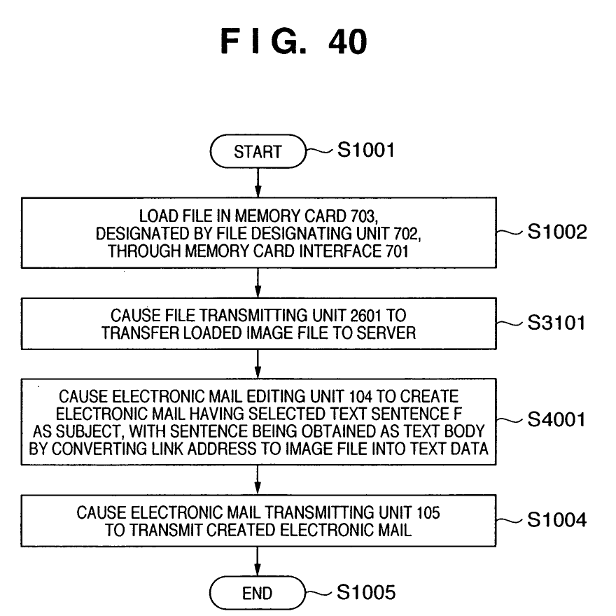

FIG. 40 is a flow chart for explaining the flow of processing in the 11th embodiment. If there is a sensing condition match, the image sensing apparatus 101c according to the 11th embodiment performs image sensing, transmits the sensed image to a server on the Internet, and transmits a link address to the image by electronic mail. In addition to this function which is the same function as in the 10th embodiment, the image sensing apparatus 101c has a function of transmitting an image file stored in a memory card 703 (see FIG. 29) to the server on the Internet and transmitting a link address to the image by electronic mail. The flow of processing in the 11th embodiment will be described with reference to the flow chart of FIG. 40.

First of all, when a file in the memory card 703 is designated by a file designating unit 702, the designated file is loaded from the memory card 703 through a memory card interface 701 (S1002). A file transmitting unit 2601 transfers the loaded image file to the server (S3101). An electronic mail editing unit 104 then creates electronic mail having the destination address set in advance in a memory (not shown) as a transmission address, with a text sentence indicating that the image data loaded from the memory card is an image in the memory being inserting in the subject, and the sentence obtained by converting a link address to the image file transferred to the server into text data being inserted in the message (S4001). The electronic mail transmitting unit 105 transmits the edited electronic mail (S1004). The processing is then terminated.

FIG. 39 shows an example of electronic mail to be transmitted by the image sensing apparatus according to the 11th embodiment. When a user who has received this electronic mail sees the subject of the electronic mail, he/she can immediately know that the image file at the link address written in the message is an image file in the memory card.

According to the 11th embodiment, when the user receives mail on which a link address to an image is written, he/she can immediately identify the image file as a file in the memory card by only seeing the subject of the mail. This makes it possible to quickly take the next action. For example, a file in the memory card has a low degree of urgency, the user may see the image later. In other cases, the user may quickly see images. In this manner, the user can set a priority order for the effective use of time.

The 11th embodiment has exemplified the memory card as a memory. However, as a memory, any medium capable of storing files, such as a RAM, hard disk, CD-ROM, or floppy disk, can be used in the same manner as described above.

[12th Embodiment]

In the ninth embodiment, the sensing time and date are converted into text data and inserted in the message of electronic mail. In the 12th embodiment, the sensing time and date are converted into text data and inserted in the subject of electronic mail.

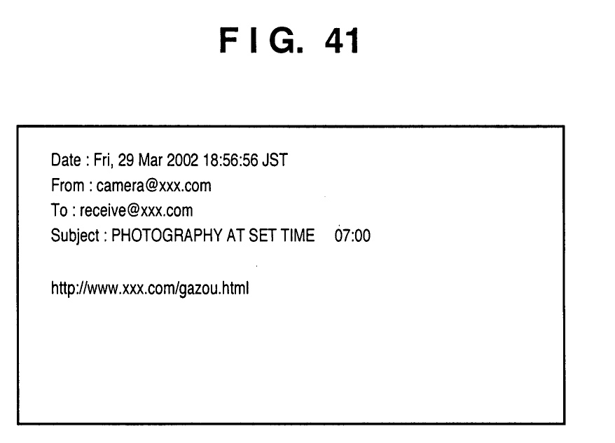

FIG. 41 is a view exemplifying the contents of electronic mail with time information being inserted in the subject of the electronic mail. FIG. 41 shows a case wherein an image file created by performing image sensing under a condition A that image sensing is to be performed at 7:00 (“take a photograph at a preset time” (see FIG. 4)) is transmitted.

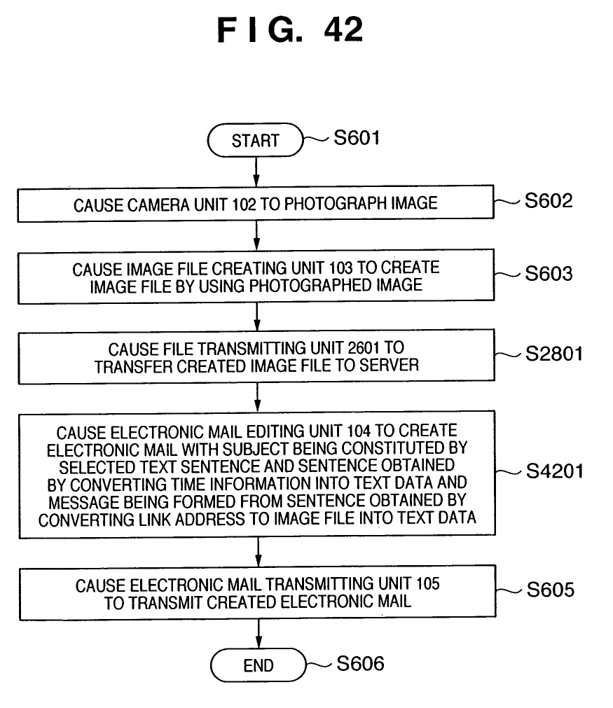

FIG. 42 is a flow chart for explaining processing in the 12th embodiment in the processing of “image sensing and mail transmission” (S516) in the flow chart of FIG. 5.

First of all, an image is sensed by a camera unit 102 (S602). An image file creating unit 103 creates an image file on the basis of the image (S603). A file transmitting unit 2601 transfers the created image file to a server (S2801). An electronic mail editing unit 104 then creates electronic mail having the destination address set in advance in a memory (not shown) as a transmission destination address, with the text sentence selected in accordance with a sensing condition and the sentence obtained by converting time information into text data being inserted in the subject, and the sentence obtained by converting a link address to the image file transferred to the server into text data being inserted in the message (S4201). An electronic mail transmitting unit 105 transmits the created electronic mail (S605). The processing is then terminated.

FIG. 41 shows an example of electronic mail to be transmitted by an image sensing apparatus 101b according to the 12th embodiment. When a user who has received the electronic mail sees the subject of the electronic mail, he/she can immediately know that the time at which the image was sensed.

According to the 12th embodiment, when the user receives mail on which a link address to an image is written by the image sensing apparatus, he/she can immediately know the specific sensing condition by only seeing the subject of the mail. This makes it possible to quickly take the next action. Even if, for example, the reception of mail is delayed by some cause, the user can assign a priority to image data in forward or reverse chronological order of sensing times or the like by seeing the sensing time in the subject. The user who has received electronic mail can therefore effectively use time by checking image data in accordance with the priority order.

In the 12th embodiment, time information is inserted in the subject of mail. However, date information may be inserted in the message of mail.

Since date information and time information are simultaneously inserted in the message of mail, the accuracy of time information improves. This makes it possible to perform accurate processing for even mail received with a delay of a day or so.

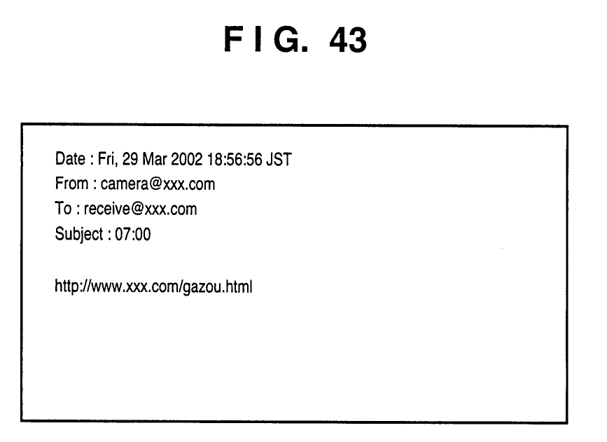

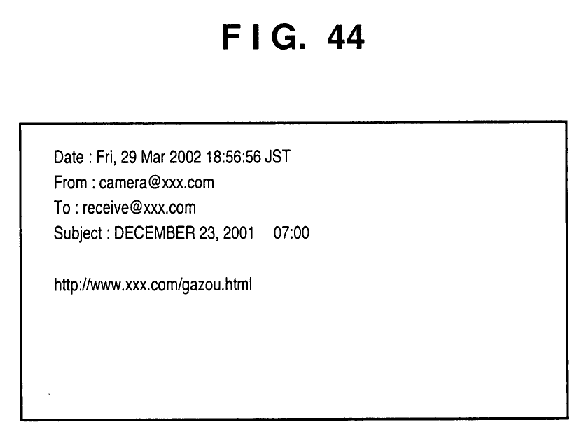

In the 12th embodiment, time information and date information are inserted in the message of mail, together with a sensing condition described in the 10th and 11th embodiments. However, the present invention is not limited to this edit form. Electronic mail may be edited by using only a sensing time as subject data (see FIG. 43), or may be edited by using only sensing time information and sensing date information as subject data (FIG. 44).

Control programs for implementing the functions of each embodiment described above (control programs for causing a computer to execute processing corresponding to the respective flow charts) are supplied to the image sensing apparatus directly or through the communication control unit 106. In this case, each program may take any form, e.g., an object code, a program executed by an interpreter, and script data supplied to an OS, as long as it has the function of the program.

As a recording medium for supplying the programs, a floppy (registered trademark) disk, hard disk, optical disk, magnetooptical disk, MO, CD-ROM, CD-R, CD-RW, magnetic tape, nonvolatile memory card, ROM, DVD (DVD-ROM or DVD-R), or the like can be used.

As has been described above, according to the present invention, the conditions under which images were sensed can be easily determined.

As many apparently widely different embodiments of the present invention can be made without departing from the spirit and scope thereof, it is to be understood that the invention is not limited to the specific embodiments thereof except as defined in the appended claims.

What is claimed is:

1. An image sensing apparatus comprising:
setting means for setting a sensing condition for image sensing;
sense means for sensing an image in accordance with the sensing condition set by said setting means; and
transmitting means for transmitting, by electronic mail, the sensing condition when the image was sensed by said sense means.

2. The apparatus according to claim 1, wherein said transmitting means transmits electronic mail having information indicating the sensing condition added to a message portion.

3. The apparatus according to claim 1, wherein said transmitting means transmits electronic mail having information indicating the sensing condition added to a subject portion.

4. The apparatus according to claim 1, wherein said transmitting means transmits the sensing condition together with the image sensed by said sense means.

5. The apparatus according to claim 1, wherein the sensing condition set by said setting means includes any one of a specific time, a predetermined elapsed time, sensor detection by an external sensor, detection of a sound level higher than a predetermined level, and operation of a sensing button.

6. The apparatus according to claim 1, wherein said transmitting means can transmit image stored in an external memory, and also transmits, when transmitting image stored in the external memory, information indicating that the transmitted image is an image that has been stored in the external memory.

7. The apparatus according to claim 1, wherein said transmitting means transmits time information indicating a time at which the image was sensed by said sense means, together with the sensing condition.

8. The apparatus according to claim 1, further comprising transfer means for transferring the image sensed by said sense means to a server connected to a network, wherein said transmitting means transmits link address information for specifying the image transmitted to the server, together with the sensing condition.

9. An image sensing apparatus comprising:
setting means for setting a sensing condition for image sensing;
sense means for sensing an image in accordance with the sensing condition set by said setting means; and
transmitting means for transmitting, by electronic mail, information associated with a time at which the image was sensed by said sense means.

10. An image sensing apparatus comprising:
setting means for setting a sensing condition for image sensing;
sense means for sensing an image in accordance with the sensing condition set by said setting means; and
electronic mail creating means for creating electronic mail to which the sensing condition under which the image was sensed by said sense means is added.

11. An image sensing apparatus comprising:
setting means for setting a sensing condition for image sensing;
sense means for sensing an image in accordance with the sensing condition set by said setting means; and
electronic mail creating means for creating electronic mail to which information associated with a time at which the image was sensed by said sense means is added.

12. A control method for an image sensing apparatus comprising:
a storing step of storing a sensing condition for image sensing;
a sensing step of sensing an image in accordance with the sensing condition stored in the storing step; and
a transmitting step of transmitting, by electronic mail, the sensing condition when the image was sensed in the sensing step.

13. A control method for an image sensing apparatus comprising:
a storing step of storing a sensing condition for image sensing;
a sensing step of sensing an image in accordance with the sensing condition stored in the storing step; and
a transmitting means of transmitting, by electronic mail, information associated with a time at which the image was sensed in the sensing step.

14. A control method for an image sensing apparatus comprising:
a storing step of storing a sensing condition for image sensing;
a sensing step of sensing an image in accordance with the sensing condition stored in the storing step; and
an electronic mail creating step of creating electronic mail to which the sensing condition when the image was sensed in the sensing step is added.

15. A control method for an image sensing apparatus comprising:
a storing step of storing a sensing condition for image sensing;
a sensing step of sensing an image in accordance with the sensing condition stored in the storing step; and
an electronic mail creating step of creating electronic mail to which information associated with a time at which the image was sensed in the sensing step is added.
